(19) United States
(12) Patent Application Publication
(10) Pub. No.: US 2009/0038558 A1
(43) Pub. Date: Feb. 12, 2009

(54) Vehicle-suspended pet trailer

(76) Inventor: Dan Schulte, Harris, MN (US)

Correspondence Address: Russ Weinzimmer, 614 Nashua St. #204, Milford, NH, 03055, US

(21) Appl. No.: 11/891,533

(22) Filed: Aug. 9, 2007

(51) Int. Cl. A01K 1/03

(52) U.S. Cl. 119/496

(57) ABSTRACT

A vehicle-suspended pet trailer is disclosed that includes at least one entry and exit facilitator and/or at least one storage tray, accessible through a cargo access door at the top of the trailer, for storing and transporting pet-related and other cargo. The pet trailer comprises a pet carrying box attached to the top of a mounting bar that can be docked with a trailer hitch attached to a vehicle. The trailer further comprises at least one entry and exit door on at least one side of the pet carrying box. In preferred embodiments, an entry and exit facilitator, such as a ramp or staircase, can be deployed between the ground and the at least one door when the pet trailer is docked with a vehicle and can be telescopically withdrawn into a door when not deployed. In some embodiments a trailer hitch ball can be docked with the mounting bar.

### FIELD OF THE INVENTION

The invention relates generally to portable pet trailers, and more particularly to pet trailers adapted for attachment to vehicles.

### BACKGROUND OF THE INVENTION

Many individuals derive great enjoyment and companionship from dogs, cats, and other pets, and many pet owners wish to take their pets with them when they run errands, visit friends, and especially when they travel for long periods of time such as when going on vacations.

Pet trailers provide a high degree of safety and convenience for pets and for people, as compared to simply carrying pets or allowing them to roam freely within a vehicle. Pet transportation boxes and crates for housing and transporting dogs and other pets are well known. However, they can be difficult to mount to the roof of a vehicle, they can be uncomfortable and even dangerous to pets if placed inside the trunk of a vehicle, and they can be cumbersome and difficult to secure if carried inside a vehicle, as well as potentially exceeding the space available and/or limiting the space for passengers.

Another approach is to transport pets in a specially designed pet trailer. However, most pet trailers are essentially complete vehicles, requiring separate wheels, being large and highly complex, requiring significant maintenance, and being high in cost.

A more promising solution is to mount a pet trailer to a bracket at the rear of a vehicle in such a way that it is suspended by the bracket, and does not require its own wheels. Typically, a vehicle-suspended pet trailer of this type is docked with a standard trailer hitch attached to the rear of a vehicle. However, vehicle-suspended pet trailers are typically suspended above the road at a level similar to the vehicle, sometimes making it difficult for pets to enter the trailer and dangerous for them to exit the trailer. Often, it is necessary to lift pets in and out of such trailers, which effectively limits the weight of pets that can be accommodated.

In addition, vehicle-suspended pet trailers do not typically offer any solutions for transporting pef food, food dishes, leashes, hunting gear, or any other items associated with pets. These items must therefore typically be transported in the vehicle, consuming space in the passenger area or the trunk.

### SUMMARY OF THE INVENTION

A vehicle-suspended pet trailer is disclosed that includes at least one ramp, stairway, and/or other entry and exit facilitator, and/or a cargo access door on the top of the trailer and at least one storage tray near the top of the trailer for storing and transportation pet-related cargo and other items, the at least one storage tray being accessible when the cargo door is open. The vehicle-suspended pet trailer comprises a pet carrying box attached to the top of a mounting bar having proximal end and a distal end, wherein the proximal end of the mounting bar can be docked with a standard vehicle trailer hitch. In preferred embodiments, the distal end of the mounting bar can be docked with a standard trailer hitch ball. The pet carrying box has at least one entry and exit door on at least one side, and in preferred embodiments at least one entry and exit facilitator, such as a ramp or a staircase, can be deployed between the ground and the at least one door when the pet trailer is docked with a vehicle. In some of these preferred embodiments at least one entry and exit facilitator is a ramp that includes cross bars, a roughened surface and/or other features to improve ease of climbing by a pet.

In other preferred embodiments, the vehicle-suspended pet trailer comprises at least one cargo access door on the top of the pet carrying box and at least one storage tray located near the top of the pet carrying box and accessible from above when the at least one cargo access door is open. In some of these preferred embodiments at least one storage tray is removable.

In further preferred embodiments, at least one vertical divider inside of the pet carrying box divides the space within the pet carrying box into at least two pet carrying spaces. At least one door provides access to each of the pet carrying spaces from at least one side of the pet carrying box.

A method for transporting at least one pet from a first location to a second location is disclosed, the method comprising providing at the first location a vehicle-suspended pet trailer as described above in a preferred embodiment that includes at least one entry and exit facilitator, opening an entry and exit door on a side of the pet carrying box, deploying an entry and exit facilitator between the ground and the entry and exit door, causing the at least one pet to enter the pet carrying box by means of the entry and exit facilitator, removing the entry and exit facilitator, closing the door, causing the vehicle to travel to the second location, thereby causing the pet to be transported along with the vehicle, opening the entry and exit door, deploying the entry and exit facilitator between the ground and the door, and causing the at least one pet to exit the pet carrying box by means of the entry and exit facilitator.

### BRIEF DESCRIPTION OF THE DRAWINGS

FIG. 1 is a perspective view from an angle of a preferred embodiment of the invention showing an open cargo access door on the top of the pet carrying box, two storage trays near the top of the pet carrying box under the cargo access door, an open first side door, a flat ramp entry and exit facilitator deployed between the ground and the side door of the pet carrying box, and a trailer hitch ball docked with the distal end of the mounting bar;

FIG. 2 is a perspective view of the preferred embodiment of FIG. 1 shown from the same angle as in FIG. 1, with the cargo access door and the first side door closed and the flat ramp entry and exit facilitator removed;

FIG. 3 is a perspective front view of the preferred embodiment and configuration of FIG. 1;

FIG. 4A is perspective front view of the preferred embodiment and configuration of FIG. 2;

FIG. 4B is perspective rear view of the preferred embodiment and configuration of FIG. 2;

FIG. 5 is a perspective left side view of the preferred embodiment and configuration of FIG. 2;

FIG. 6 is a perspective top view of the preferred embodiment and configuration of FIG. 2;

FIG. 7 is a perspective view from an angle of the preferred embodiment of FIG. 1 with the cargo access door and the storage trays removed, revealing a vertical divider that divides the interior of the pet carrying box into two pet carrying spaces;

FIG. 8 is a perspective view of a double-well storage tray removed from a pet trailer; and

FIG. 9 is a perspective view from an angle of a preferred embodiment and configuration of the invention that is similar to the preferred embodiment and configuration shown in FIG. 1, except that the entry and exit facilitator deployed between the ground and the side door of the pet carrying box is a stairway instead of a flat ramp.

### DETAILED DESCRIPTION OF PREFERRED EMBODIMENTS

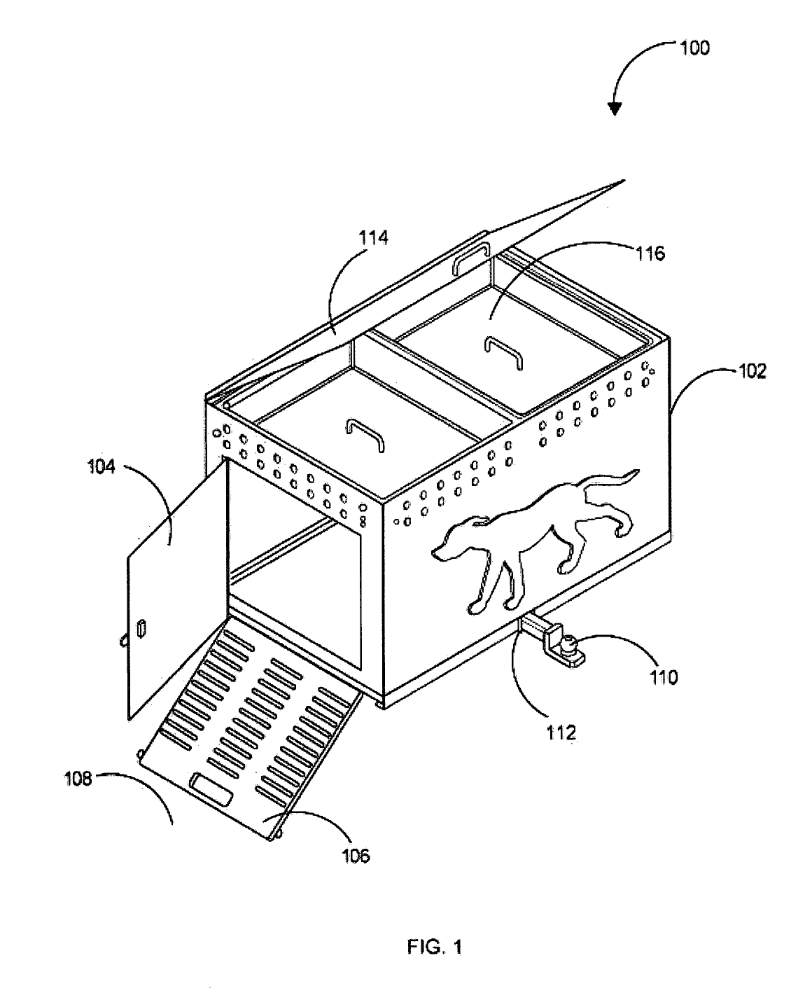

FIG. 1 shows a preferred embodiment of a vehicle-suspended pet trailer 100 attachable to a vehicle (not shown). A pet carrying box 102 attached to the top of a mounting bar (not shown) has a first side door 104 on one side. A flat ramp with grooves 106 is deployed as an entry and exit facilitator essentially between the ground 108 and the first side door 104. In the preferred embodiment of FIG. 1, the entry and exit facilitator is removable when not deployed, while in similar preferred embodiments it is telescopically collapsible into the door. A trailer hitch ball 110 is docked with the distal end 112 of the mounting bar. The pet carrying box includes a cargo access door 114 on the top of the pet carrying box 102.

The preferred embodiment of FIG. 1 further comprises a storage tray 116 located near the top of the pet carrying box 102, which in the preferred embodiment of FIG. 1 is removable from above when the cargo access door 114 is open.

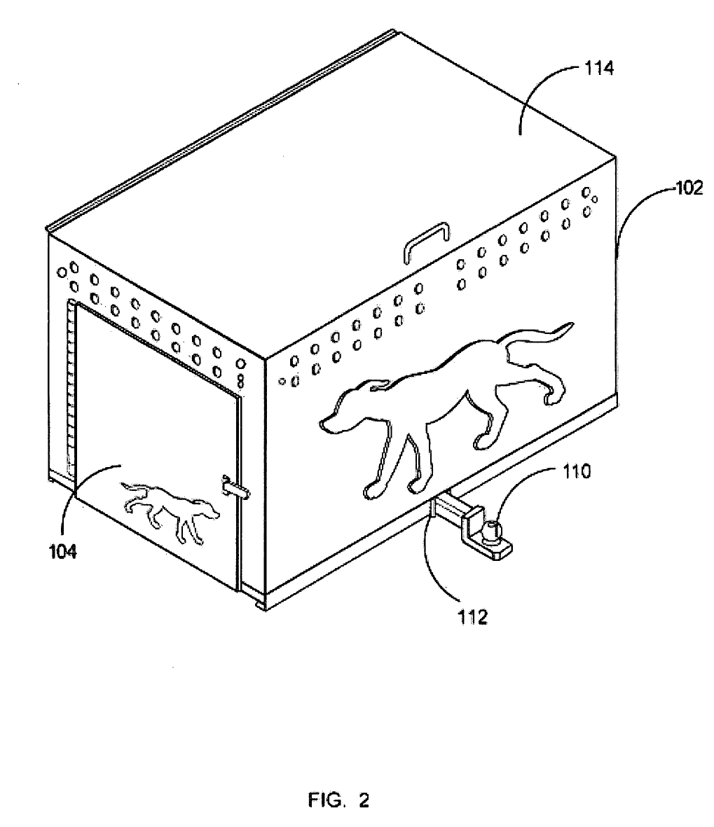

FIG. 2 is a perspective front view of the embodiment of FIG. 1, showing the first side door 104 and the cargo access door 114 closed and the entry and exit facilitator 106 removed.

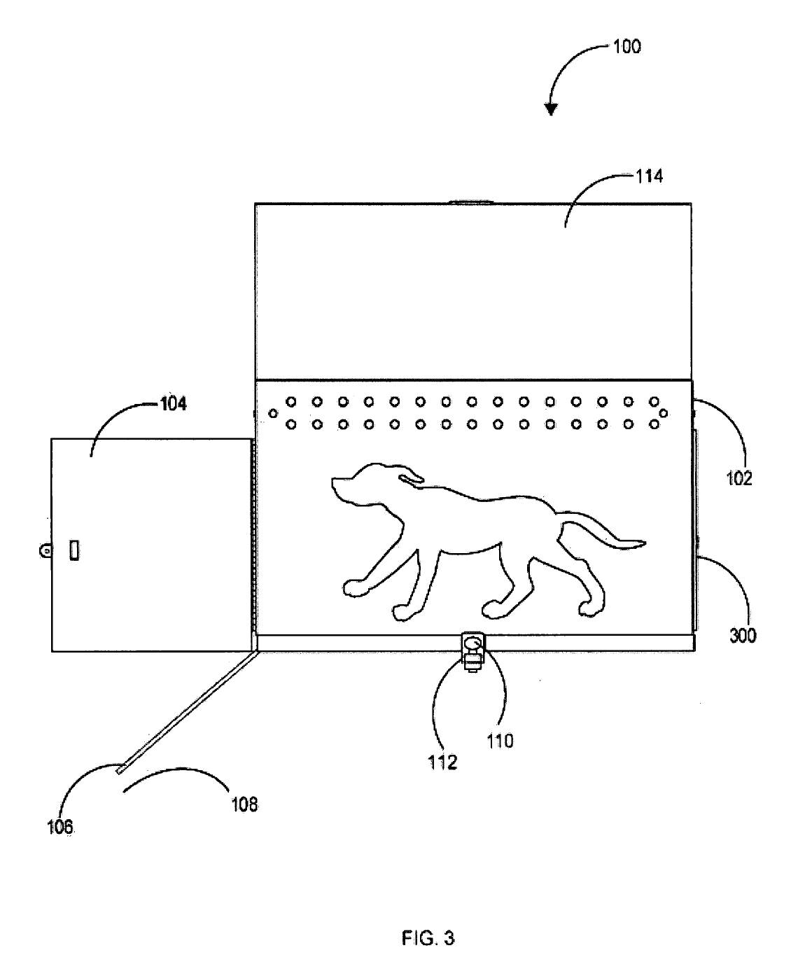

FIG. 3 is a perspective front view of the embodiment and configuration of FIG. 1, showing the cargo access door 114 and first side door 106 open and the entry and exit facilitator 106 deployed between the first side door 104 and the ground 108. A second side door 300 is shown closed on the side opposite the first side door. The trailer hitch ball 110 is shown docked with the distal 112 end of the mounting bar.

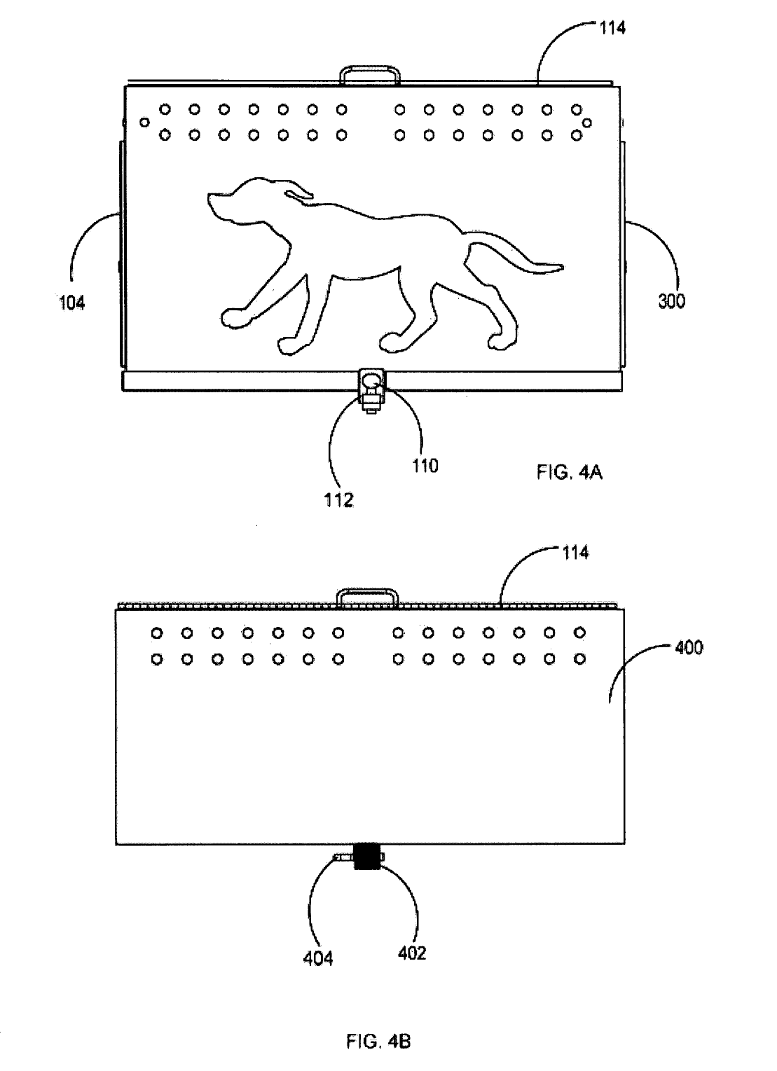

FIG. 4A is a perspective view from the front of the preferred embodiment and configuration of FIG. 2.

FIG. 4B is a perspective view from the rear of the preferred embodiment and configuration of FIG. 2, wherein the rear side 400 of the pet trailer is visible, as well as the proximal end 402 of the mounting bar, which is docked with a standard trailer hitch when the pet trailer is attached to a vehicle. A retaining pin 404, capable of fixing the proximal end of the mounting bar to a trailer hitch is shown deployed in the proximal end 402 of the mounting bar.

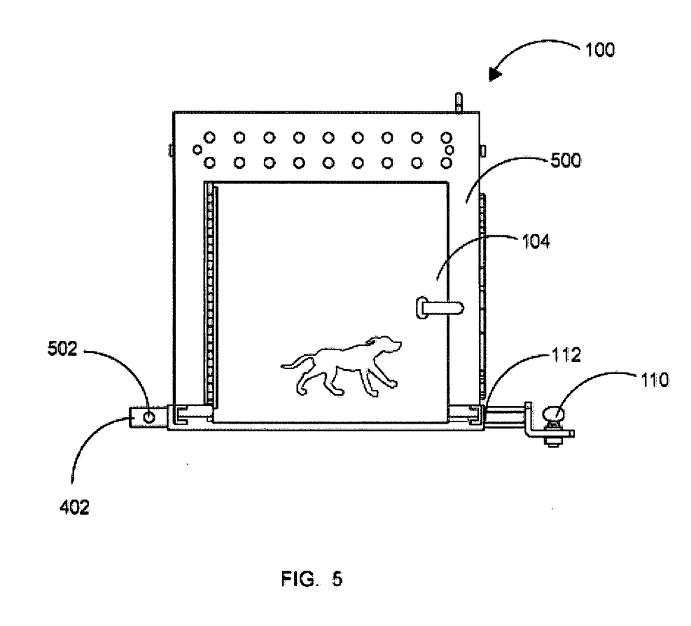

FIG. 5 is a perspective view from the side of the preferred embodiment of FIG. 1, showing the left side 500 of the pet trailer 100. The proximal end 402 of the mounting bar is visible extending from beneath the pet carrying box, and a hole 502 is visible in the proximal end 402 of the mounting bar, through which the retaining pin (404 in FIG. 4B) is inserted when the proximal end 402 of the mounting bar is docked with a trailer hitch on the rear of a vehicle.

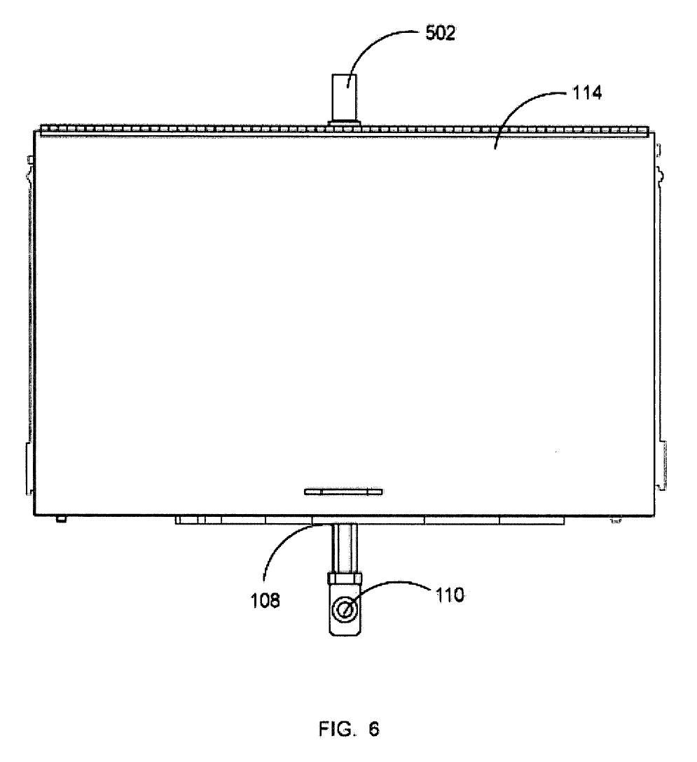

FIG. 6 is a perspective view from above of the preferred embodiment and configuration of FIG. 5.

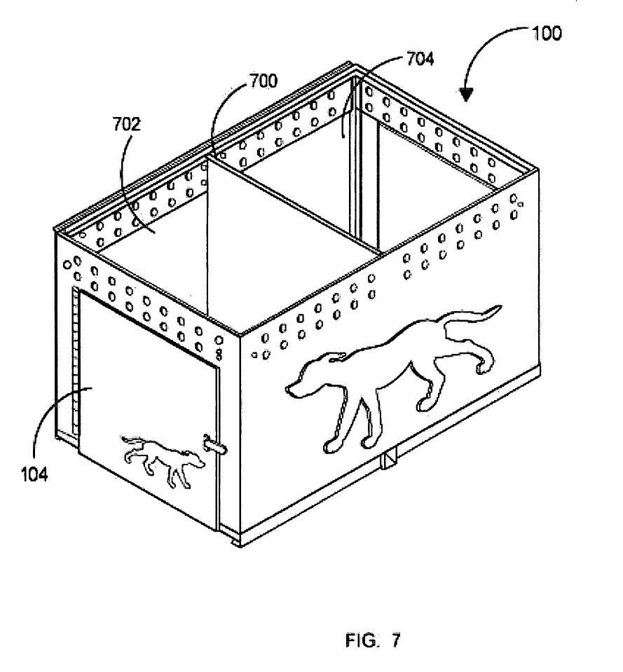

FIG. 7 is a perspective front from an angle of the preferred embodiment of FIG. 1, wherein the cargo access door and the storage trays have been removed so as to reveal a vertical divider 700 that divides the interior of the pet carrying box 100 into two pet carrying spaces 702, 704.

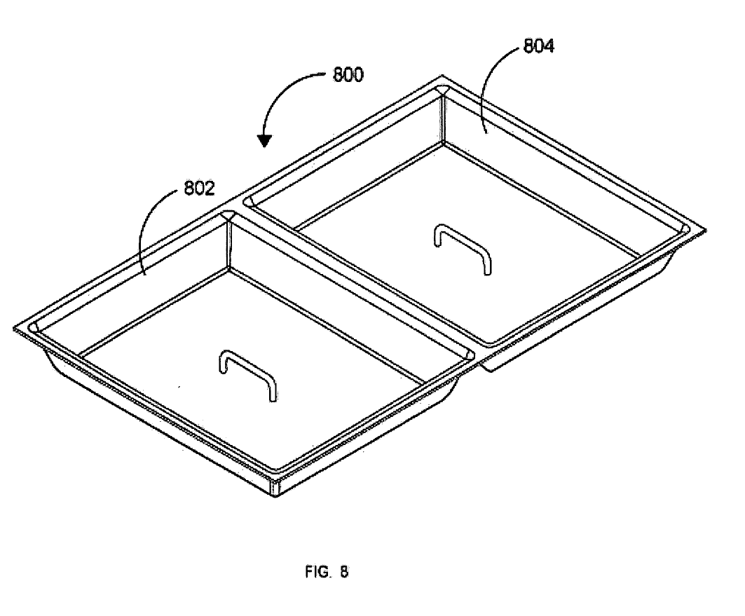

FIG. 8 is a perspective view of a double-well storage tray removed from a pet carrying box. The storage tray can be used for storage and transporting of pet related cargo and other items.

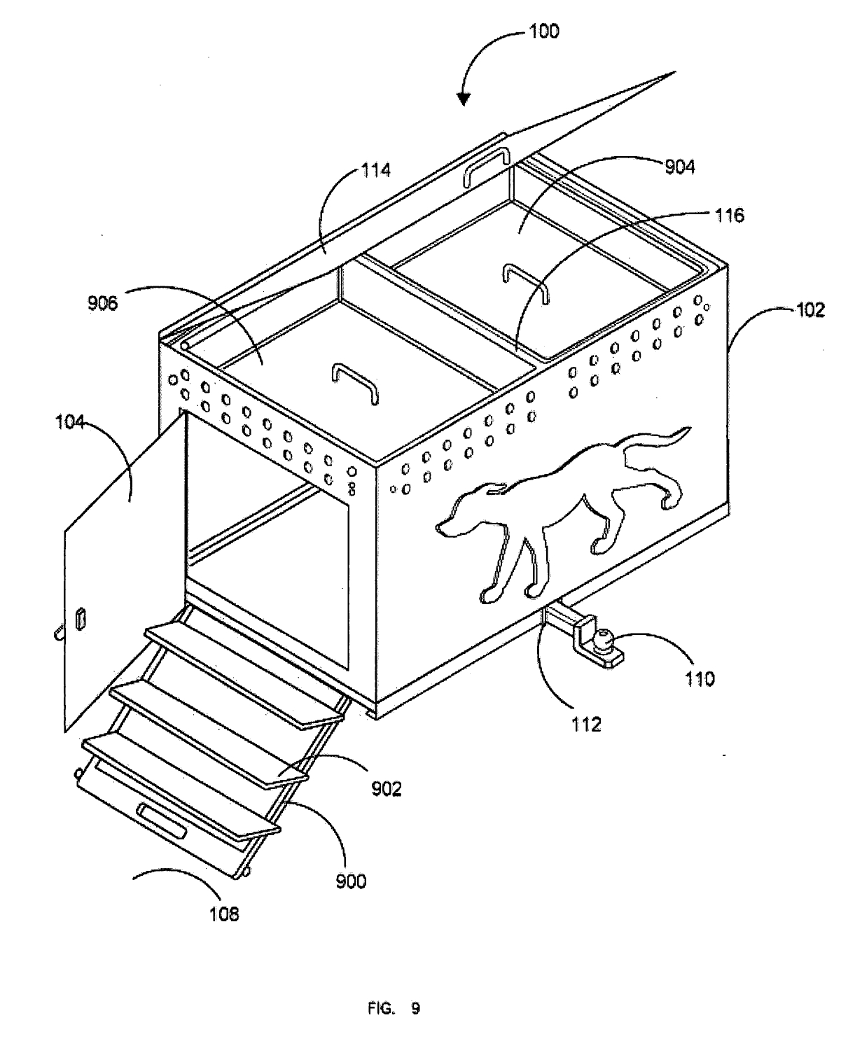

FIG. 9 is a perspective view of a preferred embodiment of the vehicle-suspended pet trailer 100 that is similar to the preferred embodiment of FIG. 1, except that the entry and exit facilitator 900 deployed between the side door 104 and the ground 108 includes steps 902 that make it easier for a pet to enter and exit the pet carrying box 102 without slipping. The pet carrying box 102 comprises a cargo access door 114 on the top, and a storage tray 116 located near the top of the pet carrying box 102 beneath the cargo access door 114. The storage tray 116 includes two storage wells 904, 906. A trailer hitch ball 110 is docked with the proximal end 112 of the mounting bar.

Other modifications and implementations will occur to those skilled in the art without departing from the spirit and the scope of the invention as claimed. Accordingly, the above description is not intended to limit the invention except as indicated in the following claims.

What is claimed is:

1. A vehicle-suspended pet trailer attachable to a vehicle, the vehicle-suspended pet trailer comprising:
a mounting bar having a top and a bottom and having a proximal end and a distal end, the proximal end being able to dock with a standard vehicle trailer hitch;
a pet carrying box attached to the top of the mounting bar, the pet carrying box containing at least one pet carrying space;
at least one pet entry and exit door on at least one side of the pet carrying box; and
at least one entry and exit facilitator that is deployable essentially between the ground and at least one entry and exit door when the proximal end of the mounting bar is docked with a trailer hitch attached to a vehicle.

2. The vehicle-suspended pet trailer of claim 1, wherein the distal end of the mounting bar can be docked with a trailer hitch ball.

3. The vehicle-suspended pet trailer of claim 1, wherein at least one entry and exit facilitator is an essentially flat ramp.

4. The vehicle-suspended pet trailer of claim 1, wherein at least one entry and exit facilitator includes at least one of steps, cross bars, a roughened surface, and other features to improve ease of climbing by a pet.

5. The vehicle-suspended pet trailer of claim 1, further comprising at least one cargo access door on the top of the pet carrying box.

6. The vehicle-suspended pet trailer of claim 5, further comprising at least one storage tray located near the top of the pet carrying box and accessible from above when the at least one cargo access door is open.

7. The vehicle-suspended pet trailer of claim 6, wherein at least one storage tray is removable.

8. The vehicle-suspended pet trailer of claim 1, further comprising at least one vertical divider that divides the inside of the pet carrying box into at least two pet carrying spaces.

9. The vehicle-suspended pet trailer of claim 1, wherein for each pet carrying space at least one entry and exit facilitator can be deployed between the ground and a door in the side of the pet carrying box so as to provide convenient entrance to and exit from the pet carrying space when the proximal end of the mounting bar is docked with a trailer hitch attached to a vehicle.

10. The vehicle-suspended pet trailer of claim 1, wherein at least one entry and exit facilitator is telescopically retractable into a pet entry and exit door when not deployed.

11. The vehicle-suspended pet trailer of claim 1, wherein at least one entry and exit facilitator can be stored under the pet carrying box when not deployed.

12. A vehicle-suspended pet trailer attachable to a vehicle, the vehicle-suspended pet trailer comprising:
a mounting bar having a top and a bottom and having a proximal end and a distal end, the proximal end being able to dock with a standard vehicle trailer hitch;
a pet carrying box attached to the top of the mounting bar, the pet carrying box containing at least one pet carrying space;
at least one pet entry and exit door on at least one side of the pet carrying box;
at least one cargo access door on the top of the pet carrying box; and
at least one storage tray located near the top of the pet carrying box and accessible from above when the at least one cargo access door is open.

13. The vehicle-suspended pet trailer of claim 12, wherein at least one storage tray is removable.

14. The vehicle-suspended pet trailer of claim 12, wherein the distal end of the mounting bar can be docked with a trailer hitch ball.

15. The vehicle-suspended pet trailer of claim 12, further comprising at least one vertical divider inside of the pet carrying box that divides the space within the pet carrying box into at least two pet carrying spaces.

16. A method of transporting at least one pet from a first location to a second location, the method comprising:
providing a vehicle-suspended pet trailer at the first location, the pet trailer comprising a mounting bar having a top and a bottom and having a proximal end and a distal end, the proximal end being able to dock with a standard vehicle trailer hitch mount, a pet carrying box attached to the top of the mounting bar, the pet carrying box containing at least one pet carrying space, at least one pet entry and exit door on at least one side of the pet carrying box, and at least one entry and exit facilitator that is deployable essentially between the ground and at least one entry and exit door when the proximal end of the mounting bar is docked with a trailer hitch attached to a vehicle;
docking the proximal end of the mounting bar with a trailer hitch attached to a vehicle;
opening at least one entry and exit door on at least one side of the pet carrying box;
deploying at least one entry and exit facilitator essentially between the ground and the at least one open entry and exit door;
causing the at least one pet to enter at least one pet carrying space inside of the pet carrying box by means of the at least one entry and exit facilitator;
removing the at least one entry and exit facilitator from the at least one entry and exit door;
closing the at least one entry and exit door;
causing the vehicle to travel to the second location, thereby causing the pet to be transported along with the vehicle;
opening at least one entry and exit door on at least one side of the pet carrying box;
deploying at least one entry and exit facilitator essentially between the ground and the at least one open entry and exit door on the side of the pet carrying box; and
causing the at least one pet to exit the at least one pet carrying space inside of the pet carrying box by means of the at least one entry and exit facilitator.
